(19) United States
(12) Patent Application Publication
(10) Pub. No.: US 2024/0160561 A1
(43) Pub. Date: May 16, 2024

(54) Exposed Physical Partitions in Solid-State Storage Devices

(71) Applicant: Western Digital Technologies, Inc., San Jose, CA (US)

(72) Inventors: Dinesh Kumar Agarwal, Bangalore (IN); Amit Sharma, BENGALURU (IN)

(21) Appl. No.: 18/448,398

(22) Filed: Aug. 11, 2023

Related U.S. Application Data
(60) Provisional application No. 63/384,034, filed on Nov. 16, 2022.

(51) Int. Cl. G06F 12/02

(52) U.S. Cl. CPC G06F 12/0246

(57) ABSTRACT

Described herein are storage devices that allow the host-computing device and various users of the storage device to understand what configurations are available for partitions and to select various configurations and preferences that can inform the storage device on how to best allocate memory blocks/dies to provide service levels and performance equal or surpassing the requested amount from the host-computing device and/or user. In this way, users can select particular die(s)/memory blocks based on their desired application. Alternatively, the user/host-computing device can indicate service quality preferences that can be parsed and translated to various characteristics that can inform the selection of the available memory blocks and dies.

### PRIORITY

This application claims the benefit of and priority to U.S. Provisional Application No. 63/384,034, filed Nov. 16, 2022, which is incorporated in its entirety herein.

### FIELD

The present disclosure relates to storage devices. More particularly, the present disclosure relates to providing visibility to various potential configurations of partitions within solid-state drives.

### BACKGROUND

Storage devices are ubiquitous within computing systems. Recently, solid-state storage devices have become increasingly common. These nonvolatile storage devices can communicate and utilize various protocols including non-volatile memory express (NVMe), and peripheral component interconnect express (PCIe) to reduce processing overhead and increase efficiency.

As the sizes of these storage devices grow, the number of blocks and other physical configurations of the drives also increases. When a host-computing device or user requests that a new partition be created, the storage device can often decide internally what memory blocks within the memory array will be allocated to the requested partition. Over time, various partitions can exist on the same dies, memory blocks, or other memory structures together.

However, in various instances, this is not ideal. Various performance gains can be realized based on the specific configuration of the selected memory devices within the storage devices. Thus, without user or host-computing device configuration inputs, the storage device can often create less ideal partitions.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a host computing device with a storage device suitable for automated fast path processing in accordance with an embodiment of the disclosure;

FIG. 2 is a schematic block diagram of a storage device suitable for automated fast path processing in accordance with an embodiment of the disclosure;

FIG. 3 is a conceptual illustration of a page of memory devices within a memory array in accordance with an embodiment of the disclosure;

FIG. 4 is a conceptual illustration of a memory array suitable for dynamic physical partition creation in accordance with an embodiment of the disclosure;

FIG. 5 is a flowchart depicting a process for a host-computing device requesting and utilizing dynamic physical partitions in accordance with an embodiment of the disclosure;

FIG. 6 is a flowchart depicting a process 600 for a storage device generating dynamic physical partitions in accordance with an embodiment of the disclosure; and

FIG. 7 is a conceptual illustration of a plurality of dynamic physical partitions 710, 720, 730, 740 in accordance with an embodiment of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the problems described above, devices and methods are discussed herein that expose the physical properties of the memory array to the host-computing device and/or the user to allow for the creation of dynamic physical partitions within the storage device. These dynamic physical partitions can be configured in various ways by selecting one or more physical structures within the memory array to allocate to the dynamic physical partition. In this way, various enhanced operations may be realized based on the desired application. For example, by generating a dynamic physical partition that utilizes all of the memory blocks on a single die only, the dynamic physical partition will typically not be susceptible to degradations in performance in response to other partitions accessing the same physical structure (die). In other examples, the user/host-computing device may desire accelerated read and or write speeds and thus generate a dynamic physical partition that utilizes memory blocks across multiple dies within the memory array in order to provide increased performance. In yet other examples, selection of memory blocks can be done to minimize wear to the memory array.

As described below, the selection of memory blocks for utilization within the dynamic physical partitions can be based on general performance selections, or may be a direct selection of various memory structures within the storage device. The selections can be for multiple dies within the memory array, a single die, multiple blocks across multiple dies, or memory blocks within a single die.

In further embodiments, the dynamic physical partitions can “borrow” memory blocks from other partitions that have been determined to have “spare” memory blocks. This dynamic allocation can allow for flexible creation and operation of the dynamic physical partitions. In many embodiments, the dynamic physical partitions have one or more predetermined thresholds that can trigger the providing of spare memory blocks and/or the allocation or borrowing of memory blocks from other partitions. This borrowing and providing memory blocks process can be dynamically operated during the operation of the storage device, and is outlined in more detail further below.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

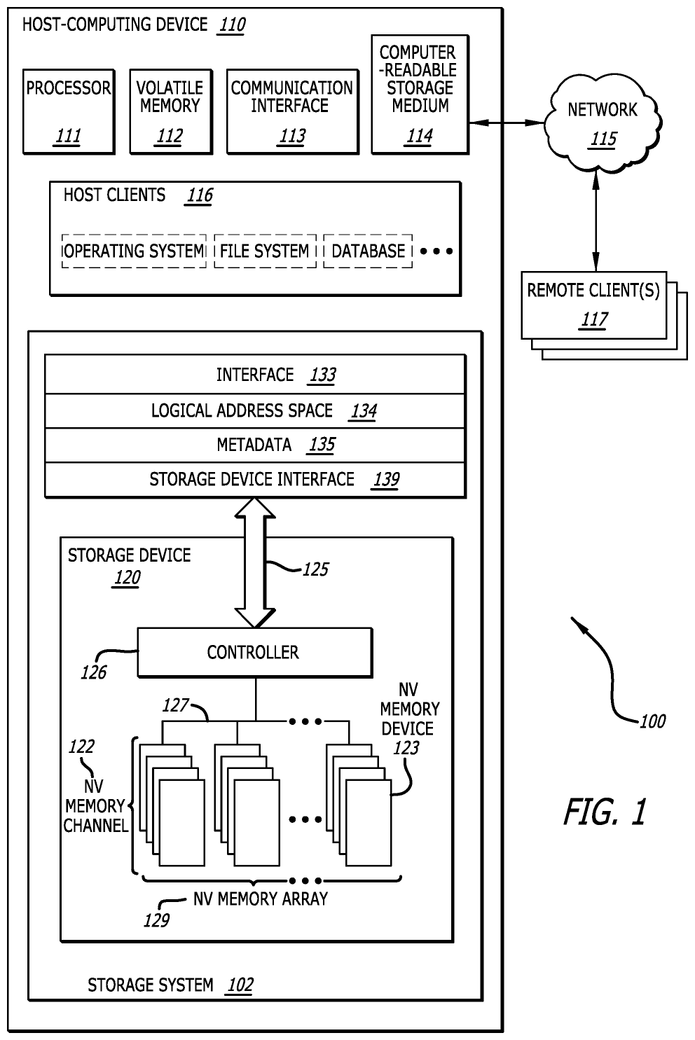

Referring to FIG. 1, a schematic block diagram of a host computing device 110 with a storage system 102 suitable for automated fast path processing in accordance with an embodiment of the disclosure is shown. The control block management system 100 comprises one or more storage devices 120 of a storage system 102 within a host computing device 110 in communication via a controller 126. The host computing device 110 may include a processor 111, volatile memory 112, and a communication interface 113. The processor 111 may include one or more central processing units, one or more general-purpose processors, one or more application-specific processors, one or more virtual processors (e.g., the host computing device 110 may be a virtual machine operating within a host), one or more processor cores, or the like. The communication interface 113 may include one or more network interfaces configured to communicatively couple the host computing device 110 and/or controller 126 of the storage device 120 to a communication network such as an Internet Protocol (IP) network, a Storage Area Network (SAN), wireless network, wired network, or the like.

The storage device 120, in various embodiments, may be disposed in one or more different locations relative to the host computing device 110. In one embodiment, the storage device 120 comprises one or more non-volatile memory devices 123, such as semiconductor chips or packages or other integrated circuit devices disposed on one or more printed circuit boards, storage housings, and/or other mechanical and/or electrical support structures. For example, the storage device 120 may comprise one or more direct inline memory module (DIMM) cards, one or more expansion cards and/or daughter cards, a solid-state-drive (SSD) or other hard drive device, and/or may have another memory and/or storage form factor. The storage device 120 may be integrated with and/or mounted on a motherboard of the host computing device 110, installed in a port and/or slot of the host computing device 110, installed on a different host computing device 110 and/or a dedicated storage appliance on the network 115, in communication with the host computing device 110 over an external bus (e.g., an external hard drive), or the like.

The storage device 120, in one embodiment, may be disposed on a memory bus of a processor 111 (e.g., on the same memory bus as the volatile memory 112, on a different memory bus from the volatile memory 112, in place of the volatile memory 112, or the like). In a further embodiment, the storage device 120 may be disposed on a peripheral bus of the host computing device 110, such as a peripheral component interconnect express (PCI Express or PCIe) bus such, as but not limited to a NVM Express (NVMe) interface, a serial Advanced Technology Attachment (SATA) bus, a parallel Advanced Technology Attachment (PATA) bus, a small computer system interface (SCSI) bus, a FireWire bus, a Fibre Channel connection, a Universal Serial Bus (USB), a PCIe Advanced Switching (PCIe-AS) bus, or the like. In another embodiment, the storage device 120 may be disposed on a communication network 115, such as an Ethernet network, an Infiniband network, SCSI RDMA over a network 115, a storage area network (SAN), a local area network (LAN), a wide area network (WAN) such as the Internet, another wired and/or wireless network 115, or the like.

The host computing device 110 may further comprise computer-readable storage medium 114. The computer-readable storage medium 114 may comprise executable instructions configured to cause the host computing device 110 (e.g., processor 111) to perform steps of one or more of the methods disclosed herein. Additionally, or in the alternative, the buffering component 150 may be embodied as one or more computer-readable instructions stored on the computer-readable storage medium 114.

A device driver and/or the controller 126, in certain embodiments, may present a logical address space 134 to the host clients 116. As used herein, a logical address space 134 refers to a logical representation of memory resources. The logical address space 134 may comprise a plurality (e.g., range) of logical addresses. As used herein, a logical address refers to any identifier for referencing a memory resource (e.g., data), including, but not limited to: a logical block address (LBA), cylinder/head/sector (CHS) address, a file name, an object identifier, an inode, a Universally Unique Identifier (UUID), a Globally Unique Identifier (GUID), a hash code, a signature, an index entry, a range, an extent, or the like.

A device driver for the storage device 120 may maintain metadata 135, such as a logical to physical address mapping structure, to map logical addresses of the logical address space 134 to media storage locations on the storage device(s) 120. A device driver may be configured to provide storage services to one or more host clients 116. The host clients 116 may include local clients operating on the host computing device 110 and/or remote clients 117 accessible via the network 115 and/or communication interface 113. The host clients 116 may include, but are not limited to: operating systems, file systems, database applications, server applications, kernel-level processes, user-level processes, applications, and the like.

In many embodiments, the host computing device 110 can include a plurality of virtual machines which may be instantiated or otherwise created based on user-request. As will be understood by those skilled in the art, a host computing device 110 may create a plurality of virtual machines configured as virtual hosts which is limited only on the available computing resources and/or demand. A hypervisor can be available to create, run, and otherwise manage the plurality of virtual machines. Each virtual machine may include a plurality of virtual host clients similar to host clients 116 that may utilize the storage system 102 to store and access data.

The device driver may be further communicatively coupled to one or more storage systems 102 which may include different types and configurations of storage devices 120 including, but not limited to: solid-state storage devices, semiconductor storage devices, SAN storage resources, or the like. The one or more storage devices 120 may comprise one or more respective controllers 126 and non-volatile memory channels 122. The device driver may provide access to the one or more storage devices 120 via any compatible protocols or interface 133 such as, but not limited to, SATA and PCIe. The metadata 135 may be used to manage and/or track data operations performed through the protocols or interfaces 133. The logical address space 134 may comprise a plurality of logical addresses, each corresponding to respective media locations of the one or more storage devices 120. The device driver may maintain metadata 135 comprising any-to-any mappings between logical addresses and media locations.

A device driver may further comprise and/or be in communication with a storage device interface 139 configured to transfer data, commands, and/or queries to the one or more storage devices 120 over a bus 125, which may include, but is not limited to: a memory bus of a processor 111, a peripheral component interconnect express (PCI Express or PCIe) bus, a serial Advanced Technology Attachment (ATA) bus, a parallel ATA bus, a small computer system interface (SCSI), FireWire, Fibre Channel, a Universal Serial Bus (USB), a PCIe Advanced Switching (PCIe-AS) bus, a network 115, Infiniband, SCSI RDMA, or the like. The storage device interface 139 may communicate with the one or more storage devices 120 using input-output control (IO-CTL) command(s), IO-CTL command extension(s), remote direct memory access, or the like. In certain embodiments, a high-priority bus 124 may be utilized to carry data to the storage device 120. However, in many embodiments, the high-priority bus 124 may be internalized within the storage device 120 only.

The communication interface 113 may comprise one or more network interfaces configured to communicatively couple the host computing device 110 and/or the controller 126 to a network 115 and/or to one or more remote clients 117 (which can act as another host). The controller 126 is part of and/or in communication with one or more storage devices 120. Although FIG. 1 depicts a single storage device 120, the disclosure is not limited in this regard and could be adapted to incorporate any number of storage devices 120.

The storage device 120 may comprise one or more non-volatile memory devices 123 of non-volatile memory channels 122, which may include but is not limited to: ReRAM, Memristor memory, programmable metallization cell memory, phase-change memory (PCM, PCME, PRAM, PCRAM, ovonic unified memory, chalcogenide RAM, or C-RAM), NAND flash memory (e.g., 2D NAND flash memory, 3D NAND flash memory), NOR flash memory, nano random access memory (nano RAM or NRAM), nanocrystal wire-based memory, silicon-oxide based sub-10 nanometer process memory, graphene memory, Silicon Oxide-Nitride-Oxide-Silicon (SONOS), programmable metallization cell (PMC), conductive-bridging RAM (CBRAM), magneto-resistive RAM (MRAM), magnetic storage media (e.g., hard disk, tape), optical storage media, or the like. The one or more non-volatile memory devices 123 of the non-volatile memory channels 122, in certain embodiments, comprise storage class memory (SCM) (e.g., write in place memory, or the like).

While the non-volatile memory channels 122 is referred to herein as “memory media,” in various embodiments, the non-volatile memory channels 122 may more generally comprise one or more non-volatile recording media capable of recording data, which may be referred to as a non-volatile memory medium, a non-volatile memory device, or the like. Further, the storage device 120, in various embodiments, may comprise a non-volatile recording device, a non-volatile memory array 129, a plurality of interconnected storage devices in an array, or the like.

The non-volatile memory channels 122 may comprise one or more non-volatile memory devices 123, which may include, but are not limited to: chips, packages, planes, die, or the like. A controller 126 may be configured to manage data operations on the non-volatile memory channels 122, and may comprise one or more processors, programmable processors (e.g., FPGAs), ASICs, micro-controllers, or the like. In some embodiments, the controller 126 is configured to store data on and/or read data from the non-volatile memory channels 122, to transfer data to/from the storage device 120, and so on.

The controller 126 may be communicatively coupled to the non-volatile memory channels 122 by way of a bus 127. The bus 127 may comprise an I/O bus for communicating data to/from the non-volatile memory devices 123. The bus 127 may further comprise a control bus for communicating addressing and other command and control information to the non-volatile memory devices 123. In some embodiments, the bus 127 may communicatively couple the non-volatile memory devices 123 to the controller 126 in parallel. This parallel access may allow the non-volatile memory devices 123 to be managed as a group, forming a non-volatile memory array 129. The non-volatile memory devices 123 may be partitioned into respective logical memory units (e.g., logical pages) and/or logical memory divisions (e.g., logical blocks). The logical memory units may be formed by logically combining physical memory units of each of the non-volatile memory devices 123.

The controller 126 may organize a block of word lines within a non-volatile memory device 123, in certain embodiments, using addresses of the word lines, such that the word lines are logically organized into a monotonically increasing sequence (e.g., decoding and/or translating addresses for word lines into a monotonically increasing sequence, or the like). In a further embodiment, word lines of a block within a non-volatile memory device 123 may be physically arranged in a monotonically increasing sequence of word line addresses, with consecutively addressed word lines also being physically adjacent (e.g., WL0, WL1, WL2, . . . WLN).

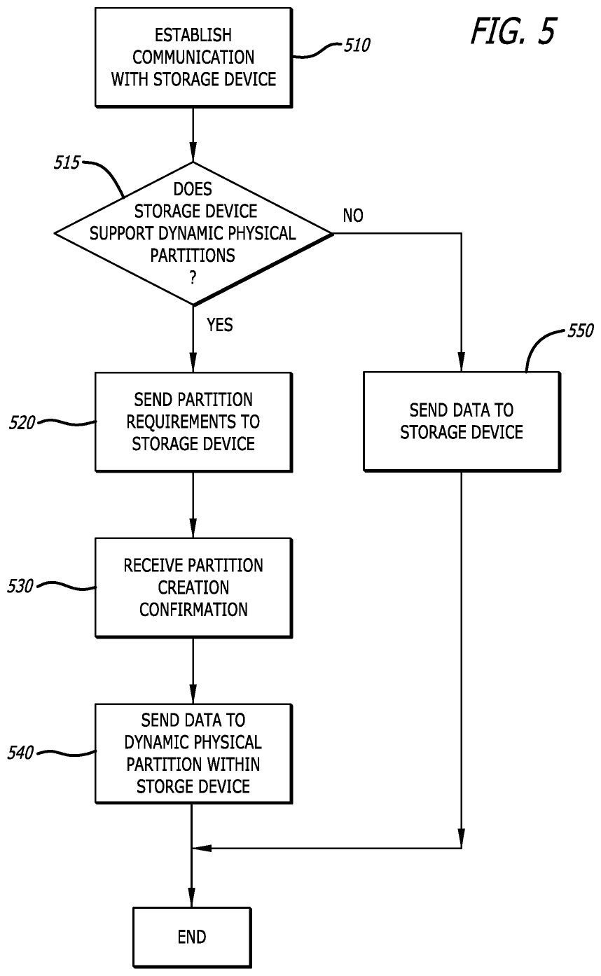

The controller 126 may comprise and/or be in communication with a device driver executing on the host computing device 110. A device driver may provide storage services to the host clients 116 via one or more interfaces 133. A device driver may further comprise a storage device interface 139 that is configured to transfer data, commands, and/or queries to the controller 126 over a bus 125, as described above. In some embodiments, the storage device interface 139 may be further configured to perform one or more actions outlined in FIG. 5 below. For example, the storage device interface 139 can, in certain embodiments, establish communication with the storage device, determine one or more partition requirements, transmit the one or more partition requirements to a storage device, receive partition creation confirmations from the storage device, as well as direct which data should be stored on which dynamic physical partition.

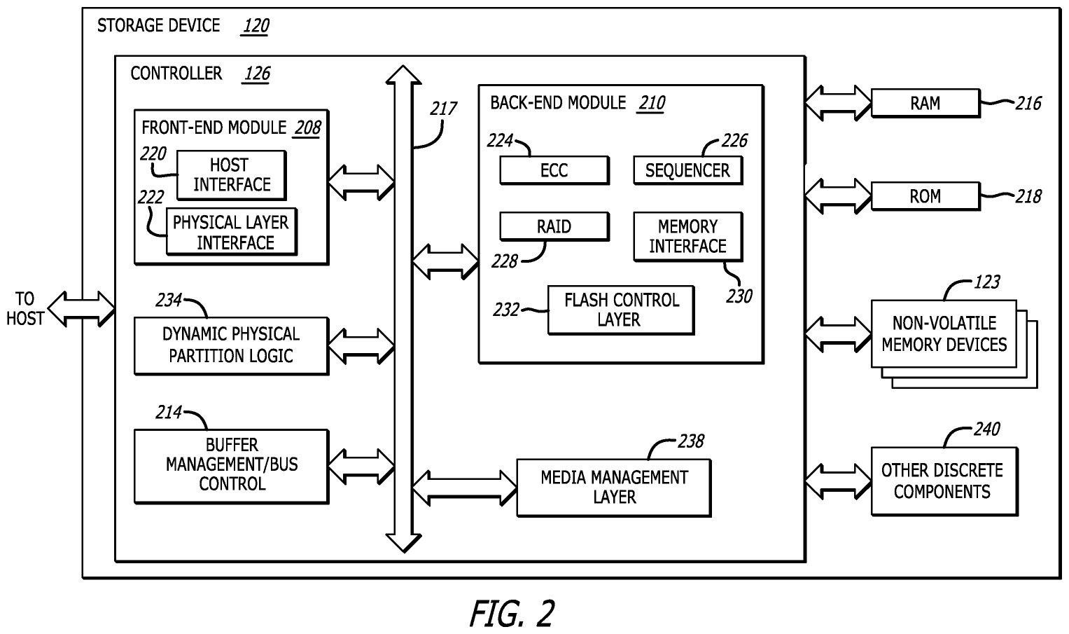

Referring to FIG. 2, a schematic block diagram of a storage device 120 suitable for automated fast path processing in accordance with an embodiment of the disclosure. The controller 126 may include a front-end module 208 that interfaces with a host via a plurality of high priority and low priority communication channels, a back-end module 210 that interfaces with the non-volatile memory devices 123, and various other modules that perform various functions of the storage device 120. In some examples, each module may just be the portion of the memory that comprises instructions executable with the processor to implement the features of the corresponding module without the module including any other hardware. Because each module includes at least some hardware even when the included hardware comprises software, each module may be interchangeably referred to as a hardware module.

The controller 126 may include a buffer management/bus control module 214 that manages buffers in random access memory (RAM) 216 and controls the internal bus arbitration for communication on an internal communications bus 217 of the controller 126. A read only memory (ROM) 218 may store and/or access system boot code. Although illustrated in FIG. 2 as located separately from the controller 126, in other embodiments one or both of the RAM 216 and the ROM 218 may be located within the controller 126. In yet other embodiments, portions of RAM 216 and ROM 218 may be located both within the controller 126 and outside the controller 126. Further, in some implementations, the controller 126, the RAM 216, and the ROM 218 may be located on separate semiconductor dies. As discussed below, in one implementation, the submission queues and the completion queues may be stored in a controller memory buffer, which may be housed in RAM 216.

Additionally, the front-end module 208 may include a host interface 220 and a physical layer interface 222 that provides the electrical interface with the host or next level storage controller. The choice of the type of the host interface 220 can depend on the type of memory being used. Example types of the host interfaces 220 may include, but are not limited to, SATA, SATA Express, SAS, Fibre Channel, USB, PCIe, and NVMe. The host interface 220 may typically facilitate transfer for data, control signals, and timing signals.

The back-end module 210 may include an error correction controller (ECC) engine 224 that encodes the data bytes received from the host and decodes and error corrects the data bytes read from the non-volatile memory devices 123. The back-end module 210 may also include a command sequencer 226 that generates command sequences, such as program, read, and erase command sequences, to be transmitted to the non-volatile memory devices 123. Additionally, the back-end module 210 may include a RAID (Redundant Array of Independent Drives) module 228 that manages generation of RAID parity and recovery of failed data. The RAID parity may be used as an additional level of integrity protection for the data being written into the storage device 120. In some cases, the RAID module 228 may be a part of the ECC engine 224. A memory interface 230 provides the command sequences to the non-volatile memory devices 123 and receives status information from the non-volatile memory devices 123. Along with the command sequences and status information, data to be programmed into and read from the non-volatile memory devices 123 may be communicated through the memory interface 230. A flash control layer 232 may control the overall operation of back-end module 210.

Additional modules of the storage device 120 illustrated in FIG. 2 may include a media management layer 238, which performs wear leveling of memory devices of the non-volatile memory devices 123. The storage device 120 may also include other discrete components 240, such as external electrical interfaces, external RAM, resistors, capacitors, or other components that may interface with controller 126. In alternative embodiments, one or more of the RAID modules 228, media management layer 238 and buffer management/bus control module 214 are optional components that may not be necessary in the controller 126.

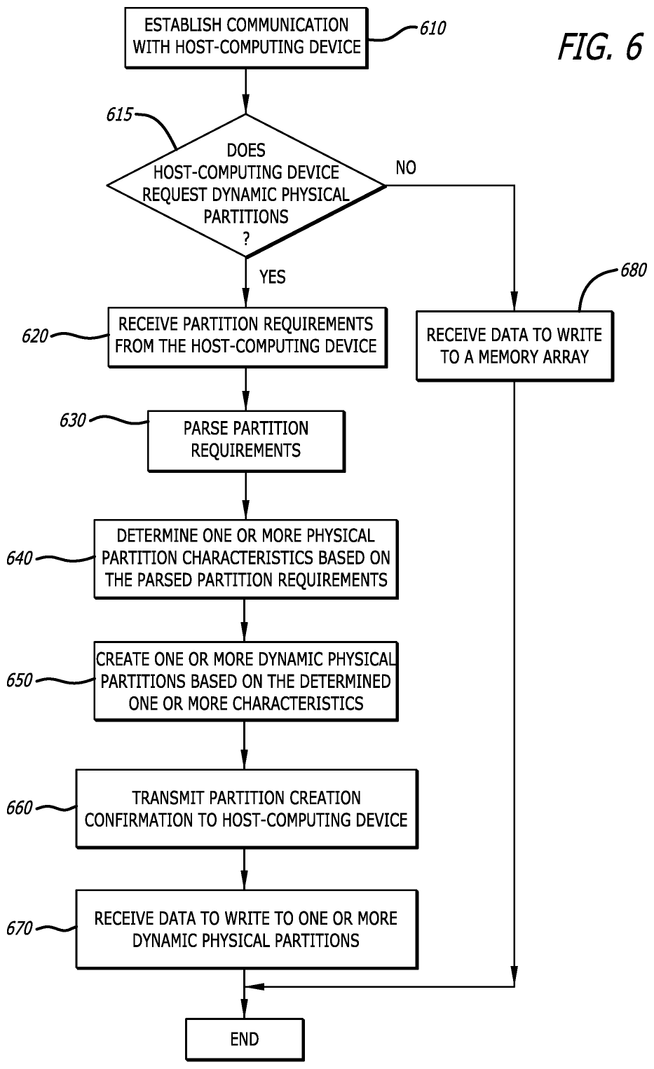

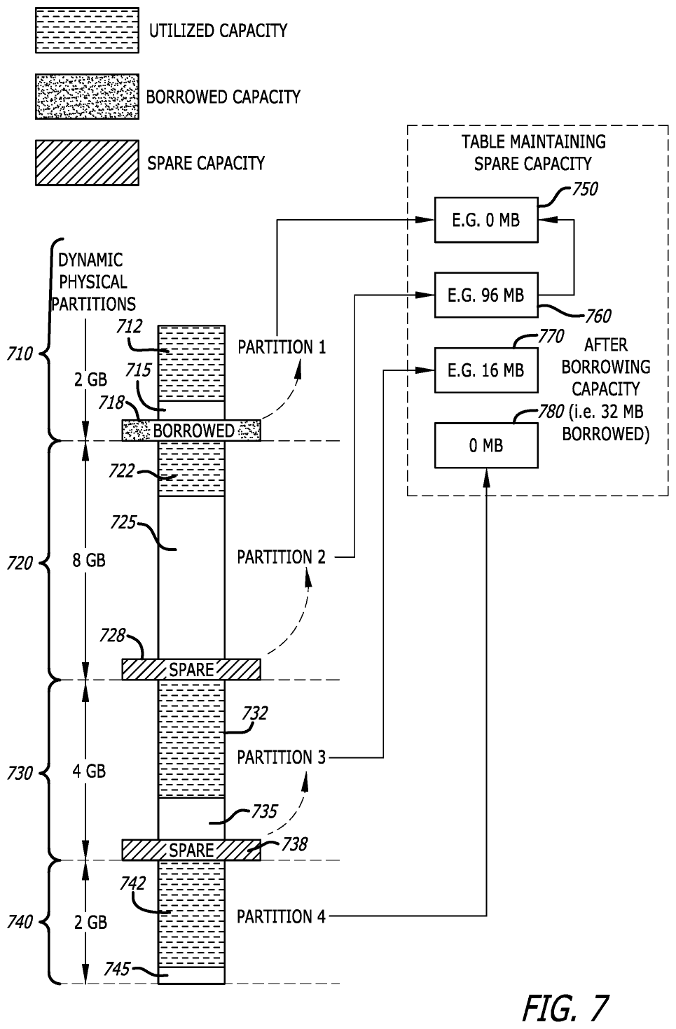

Finally, the controller 126 may also comprise a dynamic physical partition logic 234. In many embodiments the dynamic physical partition logic 234 can perform various operations, such as those outlined below in FIGS. 6 and 7. For example, the dynamic physical partition logic 234 may establish communication with a host-computing device, receive one or more partition requirements from the host-computing device, parse those received requirements, determine one or more physical partition characteristics based on the parsed partition requirements, generate one or more dynamic physical partitions based on those determined characteristics, and transmit a partition creation confirmation to the host-computing device.

In additional embodiments, the dynamic physical partition logic 234 can also receive data from the host-computing device, determine that the received data is associated with the one or more generated dynamic physical partitions, and store the received data within the one or more dynamic physical partitions. In further embodiments, the dynamic physical partition logic 234 may be further configured to receive a request for data from the host-computing device, determine that the received request is associated with the one or more generated physical partitions, retrieve the requested data within the one or more dynamic physical partitions, and transmit the requested data back to the host-computing device.

As outlined below in FIG. 7, the dynamic physical partition logic 234 may also facilitate a dynamic allocation of memory blocks within the memory array based on various conditions such as a predetermined threshold being exceeded. This predetermined threshold may be based on a variety of factors such as, but not limited to, the number of available writeable memory blocks within a dynamic physical partition, the proportion of written memory blocks to writeable memory blocks within the dynamic physical partition, and/or the determination of a large incoming block of data to be written to the dynamic physical partition.

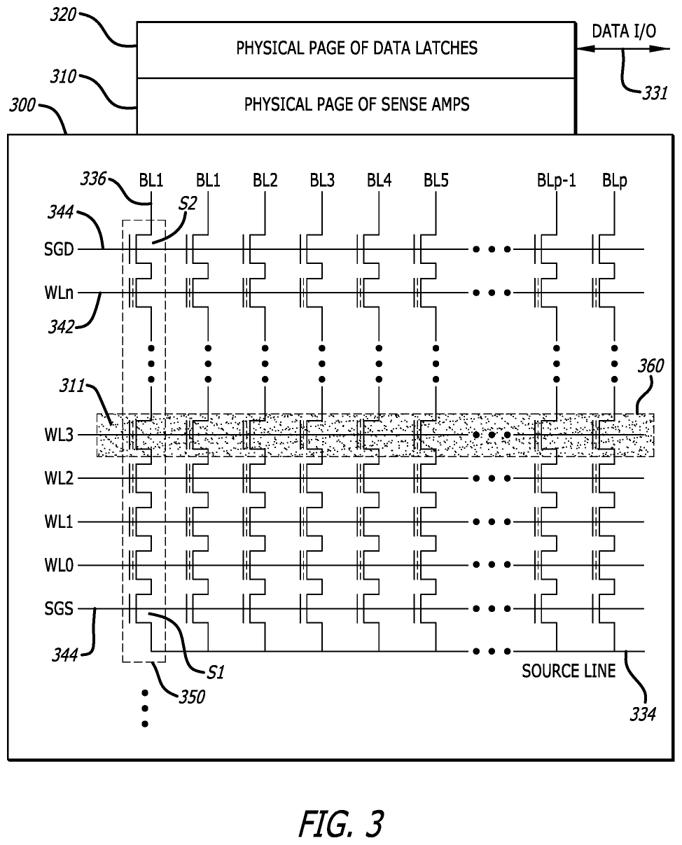

Referring to FIG. 3, a conceptual illustration of a page 360 of memory devices within a memory array in accordance with an embodiment of the disclosure is shown. FIG. 3 conceptually shows a bank of NAND strings 350 within a memory array, such as the non-volatile memory array 129 of FIG. 1 which can, in many embodiments, be configured together into one or more blocks 300, superblocks, etc. as needed. A “page” such as the page 360, is a group of memory devices enabled to be sensed or programmed in parallel. This is accomplished in the peripheral circuits by a corresponding page of sense amplifiers 310. The sensed results are utilized in latches within a corresponding set of data latches 320. Each sense amplifier can be coupled to a NAND string, such as NAND string 350 via a bit line 336. For example, the page 360 is along a row and is sensed by a sensing voltage applied to the control gates of the cells of the page connected in common to the word line WL3. Along each column, each memory device such as memory device 311 is accessible by a sense amplifier via a bit line 336. Data in the data latches 320 are toggled in from or out to the controller 126 via a data I/O bus 331.

The NAND string 350 can be a series of memory devices, such as memory device 311, daisy-chained by their sources and drains to form a source terminal and a drain terminal respective at its two ends. A pair of select transistors S1, S2 can control the memory device chain's connection to the external source via the NAND string's source terminal and drain terminal, respectively. In a memory array, when the source select transistor S1 is turned on, the source terminal is coupled to a source line 334. Similarly, when the drain select transistor S2 is turned on, the drain terminal of the NAND string is coupled to a bit line 336 of the memory array. Each memory device 311 in the chain acts to store a charge. It has a charge storage element to store a given amount of charge so as to represent an intended memory state. In many embodiments, a control gate within each memory device can allow for control over read and write operations. Often, the control gates of corresponding memory devices of each row within a plurality of NAND strings are all connected to the same word line (such as WL0. WL1 . . . WLn 342). Similarly, a control gate of each of the select transistors S1, S2 (accessed via select lines 344 SGS and SGD respectively) provides control access to the NAND string via its source terminal and drain terminal, respectively.

While the example memory devices referred to above comprises physical page memory devices that store single bits of data, in most embodiments each cell is storing multi-bit data, and each physical page can have multiple data pages. Additionally, in further embodiments, physical pages may store one or more logical sectors of data. Typically, the host computing device, such as the host computing device 110 of FIG. 1, operating with a disk operating system manages the storage of a file by organizing the content of the file in units of logical sectors, which is typically in one or more units of 512 bytes. In some embodiments, a physical page may have 16 kB of memory devices being sensed in parallel by corresponding 16 kB of sense amplifiers via 16 kB of bit lines. An example logical sector assigned by the host has a size of 2 kB of data. Thus, a physical page can store 8 sectors if the cells are each configured to store 1 bit of data (SLC). For MLC, TLC, and QLC and other increased density structures, each cell can store 2, 3, 4 or more bits of data, and each physical page can store 16, 32, 64 or more logical sectors depending on the structure utilized.

One unique difference between flash memory and other types of memory is that a memory device must be programmed from an erased state which is associated with no charge within the memory device. This requires that the floating gate must first be emptied of charge prior to programming. Programming adds a desired amount of charge back to the floating gate. It does not support removing a portion of the charge from the floating to go from a more programmed state to a lesser one. Thus, new data cannot overwrite existing data and must be written to a previously unwritten or erased location. Furthermore, erasing all the charges from a floating gate can often take an appreciable amount of time. For that reason, it will be cumbersome and inefficient to erase cell by cell or even page by page. Therefore, in most embodiments, the array of memory devices is often divided into a large number of blocks. As is common in many flash-based memory systems, the block is the unit of erase. That is, each block contains the minimum number of memory devices that are erased in one action. This combined with the limited lifespans of memory devices within the flash memory increases the desire to limit the amount of erasing and programming occurring within the storage device.

To avoid unnecessary erasing, processes to extend useful lifespans of storage devices are often utilized such as, but not limited to, wear leveling. Wear leveling attempts to write data evenly to many memory devices in order to avoid concentrated groups of memory devices from being overused before others. Thus, data passed to the storage device may not be written to the memory arrays in the same order, structure, or manner in which it was originally provided. As a result, storage devices often have to create address translation tables that can account for where a host computing device tracks the location of the memory to where that memory is actually stored within the memory array. In a number of embodiments, the storage device must look up and translate the requested location of data to a real location of the data for each read command provided by the host computing device. For certain read commands, such as random read commands, this translation and other processing can require increased processing power and time to complete the translations. Therefore, in various embodiments described below, an automated fast path can be utilized to accelerate and/or prioritize commands for processing by the memory array, bypassing the need for additional CPUs or processors.

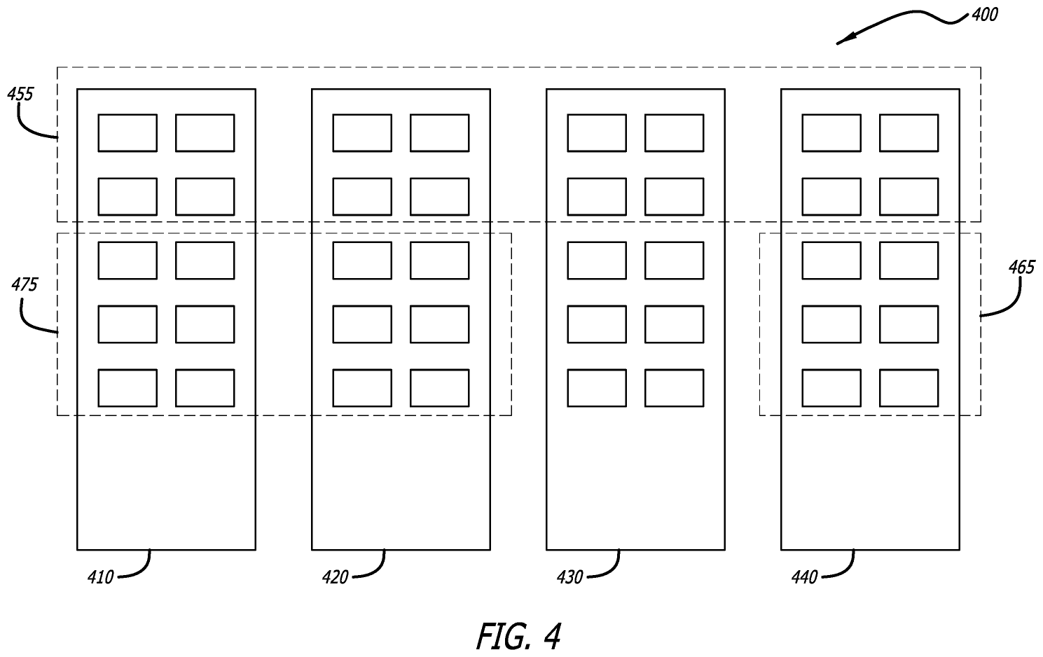

Referring to FIG. 4, a conceptual illustration of a memory array 400 suitable for dynamic physical partition creation in accordance with an embodiment of the disclosure is shown. In many embodiments, the memory array 400 can include a plurality of dies 410, 420, 430, 440. Each die may itself comprise a plurality of memory blocks which themselves can comprise various memory devices to store data.

In some embodiments, it may be desired to configure a partition to operate on a single die 410, 420, 430, 440. In these configurations, the partition is configured to allocate all memory blocks within a die to that particular partition. In these configurations, one or more increased performance benefits could be realized. In further embodiments, the dynamic physical partition could be configured to allocate memory blocks in similar positions across multiple dies, such as the cross-die grouping 455 depicted in FIG. 4. In this configuration enhanced operational benefits can be realized by allocating and operating memory blocks across each of the dies 410, 420, 430, 440.

Likewise, additional embodiments may generate dynamic physical partitions by allocating memory blocks to the partition across two or more dies, such as the second cross-die grouping 475 depicted in FIG. 4. If limitations on the first cross-die grouping 455 are present, this second cross-die grouping 475 may achieve some of the enhanced operational benefits beyond what would be a traditional partition. Finally, in some embodiments, a dynamic physical partition may be configured as a single-die grouping 465 that allocates a continuous portion of a die to the partition.

It is contemplated that other memory configurations may occur within a storage device 400. The example depicted in FIG. 4 is simplified for descriptive purposes. Storage devices may be configured in any number of structures and variations based upon the application desired. Other memory structures beyond dies and memory blocks may also be utilized. Often, the memory structures that can be utilized include structures that offer one or more advantages if configured into a particular arrangement. These advantages may be increased operating speed, reduced wait times, or lower amounts of wear to the memory devices.

Referring to FIG. 5, a flowchart depicting a process 500 for a host-computing device requesting and utilizing dynamic physical partitions in accordance with an embodiment of the disclosure is shown. In many embodiments, the process 500 can establish communication with a storage device (block 510). This communication may be through an internal connection over one or more communication protocols, or it may be a remote connection outside of a host-computing device.

Upon establishing the communication connection, the process 500 can determine if the storage device support dynamic physical partitions (block 515). This determination can be through the polling of the storage device, or it can be via a check of one or more flags or other indicators located within the storage device. These internal flags or other indicators may have been previously generated via a handshake routine upon connection of the storage device or based upon past polling.

If the storage device does not support dynamic physical partitions, the process 500 can send data to the storage device (block 550). The storage device may also create traditional partitions as required. However, when the storage device does support dynamic physical partitions, the process 500 can send partition requirements to the storage device (block 520). These partition requirements can be generated within the host-computing device based on various inputs. In some embodiments, the host-computing device will internally generate the partition requirements based on various factors related to desired performance or past use for example. In more embodiments, the host-computing device will accept input from a user that indicates the desired performance or other requirements of the new partition.

In some embodiments, the user may indicate general partition operating desires or requirements associated with performance and/or durability. For example, the user may indicate that they desire a partition capable of a certain speed or to maximize the lifespan of the storage device memory array. In further embodiments, the user may be given a textual and/or visual representation of the memory array within the storage device and given a means to indicate which specific memory structures are to be included within the dynamic physical partition. For example, the user may indicate that they want to only allocate memory blocks in a single die to the new partition, or that similar memory blocks across two or more, or even all dies should be allocated.

Eventually, the process 500 can receive a confirmation of the creation of the dynamic physical partition (block 530). Once confirmed, the process 500 can send data to the dynamic physical partition within the storage device (block 540). Eventually, if the dynamic physical partition has to few available memory devices, the process 500 may dynamically borrow memory devices from another partition. This process is highlight below in the discussion of FIG. 7.

Referring to FIG. 6, a flowchart depicting a process 600 for a storage device generating dynamic physical partitions in accordance with an embodiment of the disclosure is shown. In many embodiments, the process 600 can first establish communication with the host-computing device (block 610). This communication may again be through an internal connection over one or more communication protocols, or it may be a remote connection outside of a host-computing device.

Upon establishment, the process 600 can determine if the host-computing device is requesting a dynamic physical partition (block 615). In various embodiments, a storage device may be configured to allow for the creation of traditional partitions as well as dynamic physical partitions. If the host-computing device does not request the creation of a dynamic physical partition, a standard partition can be created, and data may be received to write to the memory array associated with that traditional partition (block 680).

However, when the host-computing device does request a dynamic physical partition to be created, the process 600 can receive partition requirements from the host-computing device (block 620). As described above in the discussion of FIG. 5, the partition requirements can come from a variety of sources. The process 600 can parse those received partition requirements (block 630).

Once parsed, the process 600 can determine one or more physical partition characteristics based on the parsed partition requirements (block 640). As shown in the discussion of FIG. 4, the physical partition characteristics can be related to the number and configuration of memory structures selected to be allocated to the dynamic physical partition. For example, the physical partition characteristics may indicate that a dynamic physical partition should be created by allocating blocks across multiple dies, or by allocating the entirety of a single die to that particular partition.

Once determined, the process 600 can create one or more dynamic physical partitions based on those one or more characteristics (block 650). In some embodiments, these partitions may be generated across multiple memory arrays. Once the creation has been successfully completed, the process 600 can transmit a partition creation confirmation to the host-computing device (block 660). In this way, the host-computing device can be notified that it is suitable to begin sending data to store within the dynamic physical partition. Subsequently, the storage device may receive data to write to one or more previously created dynamic physical partitions (block 670).

Referring to FIG. 7, a conceptual illustration of a plurality of dynamic physical partitions 710, 720, 730, 740 in accordance with an embodiment of the disclosure is shown. In many embodiments, a dynamic physical partition may be allocated a particular amount of memory devices across various memory structures such as, but not limited to, memory blocks, dies, etc. However, various operations may occur to dynamically adjust the size of the partition in response to various conditions occurring, such as, but not limited to, the number of writeable memory devices falling below a predetermined threshold.

The embodiment depicted in FIG. 7 includes a first dynamic physical partition 710 which is allocated two gigabytes of memory devices. The first dynamic physical partition 710 has a utilized capacity 712 which indicates the portion currently filled with data. The empty capacity 715 indicates the number of free memory devices remaining in the dynamic physical partition 710. At some point, the amount of utilized capacity 712 and/or the amount of empty capacity 715 passed a predetermined threshold, triggering the generation of a borrowed capacity 718. The predetermined threshold may be associated with too few writeable memory devices remaining in the first dynamic physical partition 710 or may be related to the portion of utilized capacity 712 within the first dynamic physical partition 710.

Conversely, a second dynamic physical partition 720 has been allocated with eight gigabytes of memory devices. The second dynamic physical partition 720 has a second utilized capacity 722 and a second empty capacity 725 comprising memory devices that are available for writing data to. Because the proportion of utilized to empty capacity is low, the second dynamic physical partition 720 can be configured to allow for the “borrowing” of memory devices. This borrowing can be realized by generating a first spare capacity 728 within the second dynamic physical partition 720. This spare capacity can be generated upon various conditions occurring, such as a predetermined threshold being passed, upon a request of another partition, etc.

Similarly, a third dynamic physical partition 730 is allocated with four gigabytes of memory devices that has a third utilized capacity 732, a corresponding empty capacity 735 and a second spare capacity 738. Finally, a fourth dynamic physical partition 740 is allocated with two gigabytes of memory devices which includes a fourth utilized capacity 742, and a fourth empty capacity 745. Because there is a low amount of empty capacity 745 remaining in the fourth dynamic physical partition 740, there is insufficient empty capacity 745 to provide a spare capacity.

Based on the allocations and configuration depicted in the embodiment of FIG. 7, the second dynamic physical partition 720 provides a second spare capacity 728 that has a corresponding second entry 760 within a managing table indicating that ninety-six megabytes of capacity is available for borrowing. Likewise, the third spare capacity 738 is represented by a third entry 770 that indicates that sixteen megabytes of memory devices are available for borrowing. Because the fourth dynamic physical partition 740 does not have sufficient available writeable memory devices, the corresponding fourth entry 780 indicates that no amount of memory is available to borrow from. Finally, the first entry 750 indicates that no memory devices are available for borrowing as the first dynamic physical partition 710 is currently borrowing data from the second spare capacity 728.

It is contemplated that other various configurations are available based on the structure of the storage device and memory array, or the application desired. The embodiment depicted in FIG. 7 is provided for conceptual illustrative purposes and is simplified for better understanding. Additionally, the method of marking and/or indicating whether spare capacity is available may be realized through other data structures and/or methods.

Information as herein shown and described in detail is fully capable of attaining the above-described object of the present disclosure, the presently preferred embodiment of the present disclosure, and is, thus, representative of the subject matter that is broadly contemplated by the present disclosure. The scope of the present disclosure fully encompasses other embodiments that might become obvious to those skilled in the art, and is to be limited, accordingly, by nothing other than the appended claims. Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, work-piece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device comprising:
a processor;
a memory array comprising a plurality of memory devices wherein the memory devices are configured into a plurality of physical configurations; and
a dynamic physical partition logic configured to:
establish communication with a host-computing device;
receive one or more partition requirements from the host-computing device;
parse the received partition requirements;
determine one or more dynamic physical partition characteristics based on the parsed partition requirements;
generate one or more dynamic physical partitions based on the determined characteristics; and
transmit partition creation confirmation to host-computing device.

2. The device of claim 1, wherein the physical configurations comprise a plurality of dies within the memory array.

3. The device of claim 2, wherein the plurality of dies further comprises a plurality of blocks.

4. The device of claim 3, wherein the physical partition characteristics include operating a partition on a single die.

5. The device of claim 4, wherein the partition is configured to utilize all memory blocks within the single die.

6. The device of claim 3, wherein the dynamic physical partition characteristics include operating a partition on a plurality of blocks disposed on multiple dies.

7. The device of claim 3, wherein the dynamic physical partition characteristics include operating a partition on a first die and a plurality of blocks disposed at last on a second and third die.

8. The device of claim 1, wherein the dynamic physical partition logic if further configured to:
receive data from the host-computing device;
determine that the received data is associated with the one or more generated dynamic physical partitions; and
store the received data within the one or more dynamic physical partitions.

9. The device of claim 1, wherein the dynamic physical partition logic if further configured to:
receive a request for data from the host-computing device;
determine that the received request is associated with the one or more generated dynamic physical partitions; and
retrieve the requested data within the one or more dynamic physical partitions;
transmit the requested data to the host-computing device.

10. The device of claim 1, wherein a physical partition is configured to borrow memory devices assigned to a different partition.

11. The device of claim 10, wherein the borrowing is configured to occur upon the available memory devices within the physical partition falls below a predetermined threshold.

12. A device comprising:
a processor;
a storage device communicatively coupled to the processor, wherein the storage device comprises a memory array comprising a plurality of memory devices wherein the memory devices are configured into a plurality of physical configurations; and
a storage device interface configured to:
establish communication with storage device;
determine one or more partition requirements;
transmit the one or more determined partition requirements to the storage device;
receive a partition creation confirmation from the storage device.

13. The device of claim 12, wherein the one or more partition requirements comprise providing a minimum write time.

14. The device of claim 12, wherein the one or more partition requirements comprise providing a minimum read time.

15. The device of claim 12, wherein the determining the one or more partition requirements is based on received user input.

16. The device of claim 15, wherein the received user input comprises a preference on the configuration of the physical partition.

17. The device of claim 12, wherein the preference of the physical configuration comprises a utilizing a single die within the memory array.

18. The device of claim 17, wherein the preference of the physical configuration comprises a specific plurality of dies within the memory array.

19. The device of claim 17, wherein the preference of the physical configuration comprises utilizing a particular plurality of blocks within the memory array.

20. The device of claim 17, wherein the plurality of blocks is selected from across two or more dies within the memory array.

21. A device comprising:
a processor;
a memory array comprising a plurality of memory devices wherein the memory devices are configured into a plurality of physical configurations; and
a dynamic physical partition logic configured to:
establish communication with a host-computing device;
receive one or more partition requirements from the host-computing device;
parse the received partition requirements;
determine one or more physical partition characteristics based on the parsed partition requirements;
generate one or more physical partitions based on the determined characteristics;
transmit partition creation confirmation to host-computing device receive data from the host-computing device;
determine that the received data is associated with the one or more generated physical partitions;
store the received data within the one or more physical partitions; and
allocate, in response to the number of empty memory devices within the memory array falls below a pre-determined threshold, a plurality of memory blocks from a separate partition.
